(19) United States
(12) Patent Application Publication
(10) Pub. No.: US 2013/0208948 A1
(43) Pub. Date: Aug. 15, 2013

(54) TRACKING AND IDENTIFICATION OF A MOVING OBJECT FROM A MOVING SENSOR USING A 3D MODEL

(71) Applicants: Erez Berkovich, Kfar Biyalik (IL); Dror Shapira, Kfar Biyalik (IL); Gil Briskin, Givat Zeev (IL); Omri Peleg, Beit Zait (IL)

(72) Inventors: Erez Berkovich, Kfar Biyalik (IL); Dror Shapira, Kfar Biyalik (IL); Gil Briskin, Givat Zeev (IL); Omri Peleg, Beit Zait (IL)

(73) Assignee: Rafael Advanced Defense Systems Ltd., Haifa (IL)

(21) Appl. No.: 13/824,371

(22) PCT Filed: Oct. 6, 2011
(86) PCT No.: PCT/IL11/00791

§ 371 Date: Mar. 17, 2013

(30) Foreign Application Priority Data
Oct. 24, 2010 (IL) 208910

(51) Int. Cl. H04N 13/02; G06K 9/32

(52) U.S. Cl. CPC H04N 13/0203; G06K 9/3233
USPC 382/103; 348/46

(57) ABSTRACT

A system and method for detection, tracking, classification, and/or identification of a moving object from a moving sensor uses a three-dimensional (3D) model. The system facilitates generation of a 3D model using images from a variety of sensors, in particular passive two-dimensional (2D) image capture devices. 2D images are processed to determine viewpoint and find moving objects in the 2D images. Conventional techniques or an innovative technique can be used to find segments of 2D images having moving objects. Viewpoint and segment information is used for generation of a 3D model of an object, in particular using both object motion and sensor motion to generate the 3D model.

### FIELD OF THE INVENTION

The present embodiment generally relates to the field of image processing, and in particular, it concerns a system and method for detection, tracking, classification, and identification of a moving object from a moving sensor using a three-dimensional (3D) model.

### BACKGROUND OF THE INVENTION

Detecting, tracking, classification, and identifying objects in a real scene is an important application in the field of computer vision. Detection and tracking techniques are used in many areas, including security, monitoring, research, and analysis. In the context of this document, objects are also sometimes referred to as targets. In addition to detecting and tracking an object, it is often desirable to classify an object into a general category (for example, person, building, or car) and identify a specific object (who is the person, what building, which car). The problems of tracking and identification have been addressed using a variety of techniques. One non-limiting example of a specific area of tracking objects is tracking of people as the people move within the view of a security camera, and further recognizing the identity of a specific person. Conventional solutions for tracking objects use a variety of sensors, such as thermal, RADAR, and video sensors. Much research has been done in the areas of stabilizing a moving sensor and processing the input from a moving sensor. RADAR is a popular choice for tracking moving targets, and techniques exist for tracking a moving object from a moving RADAR.

RADAR is an example of an active sensing technique. Known problems with active techniques include having to generate an active signal, and that the radio waves, or other electromagnetic signal used to locate (also known as marking) a target can be detected. There are many cases in which it is not feasible to generate an active signal, or not desirable for a target to be able to detect an active signal. Passive techniques do not require signal generation and can be used without a target being able to detect that the target is being marked. Many conventional techniques exist for tracking a moving object using a stationary passive sensor.

When attempting to track an object, there are advantages to being able to create a three-dimensional (3D) model of the object. A variety of conventional techniques exist to create a 3D model of a stationary object using a moving camera, and a 3D model of a moving object using one of more stationary cameras.

A summary of tracking techniques is referenced by Richard J. Qian, et al in U.S. Pat. No. 6,404,900, Method for robust human face tracking in presence of multiple persons. Qian teaches a method for outputting the location and size of tracked faces in an image. This method includes taking a frame from a color video sequence and filtering the image based on a projection histogram and estimating the locations and sizes of faces in the filtered image.

U.S. Pat. No. 6,384,414 to Fisher, et al for Method and apparatus for detecting the presence of an object, teaches a method and apparatus for detecting and classifying an object, including a human intruder. The apparatus includes one or more passive thermal radiation sensors that generate a plurality of signals responsive to thermal radiation. A calculation circuit compares the plurality of signals to a threshold condition and outputs an alarm signal when the threshold condition is met, indicating the presence of the object. The method includes detecting thermal radiation from an object at a first and second wavelength and generating a first and second responsive signal. The signals are compared to a threshold condition that indicates whether the object is an intruder.

Conventional solutions include techniques for stabilizing a moving sensor U.S. Pat. No. 7,411,167 to Ariyur, et al. for Tracking a Moving Object from a Camera on a Moving Platform teaches a method to dynamically stabilize a target image formed on an image plane of an imaging device located in a moving vehicle. The method includes setting an origin in the image plane of the imaging device at an intersection of a first axis, a second axis and a third axis, imaging a target so that an image centroid of the target image is at the origin of the image plane, monitoring sensor data indicative of a motion of the vehicle, and generating pan and tilt output to stabilize the image centroid at the origin in the image plane to compensate for vehicle motion and target motion. The pan and tilt output are generated by implementing exponentially stabilizing control laws. The implementation of the exponentially stabilizing control laws is based at least in part on the sensor data.

U.S. Pat. No. 6,204,804 to Bengt Lennart Andersson for Method for Determining Object Movement Data teaches precisely determining the velocity vector of a moving object by using radar measurements of the angle to and the radial speed of a moving object. This can be done in a radar system comprising one or more units. The technique also makes it possible to precisely determine the range to a moving object from a single moving radar unit. Bengt does not generate a 3D model of the target or provide for classification or identification of the target.

U.S. Pat. No. 5,122,803 to Staun, et al for Moving Target Imaging Synthetic Aperture Radar teaches a method and apparatus of imaging moving targets with an aircraft mounted complex radar system having a plurality of independent, but synchronized synthetic aperture radars (SARs) positioned on the aircraft at equal separation distance along the flight velocity vector of the aircraft.

U.S. Pat. No. 6,002,782 to Dionysian for System And Method For Recognizing A 3-D Object By Generating A 2-D Image Of The Object From A Transformed 3-D Model teaches the advantages of using a 3D model of an object for comparison.

Israel patent application number 203089 to Peleg, et al, for System and Method for Reconstruction of Range Images from Multiple Two-Dimensional Images Using a Range Based Variational Method teaches the advantages of using 3D models and compares techniques for generation of 3D models.

There is therefore a need for a method and system for detection, tracking, and identification of a moving object from a moving sensor. It is preferable for this method to be useable by a variety of sensors, in particular passive sensors such as image capture devices.

### SUMMARY

The present embodiment is a system and method for detection, tracking, classification, and identification of a moving object from a moving sensor using a three-dimensional (3D) model. The system facilitates generation of a 3D model using images from a variety of sensors, in particular passive two-dimensional (2D) image capture devices. 2D images are processed to determine viewpoint and find moving objects in the 2D images. Conventional techniques or an innovative technique can be used to find segments of 2D images having moving objects. Viewpoint and segment information is used for generation of a 3D model of an object, in particular using both object motion and sensor motion to generate the 3D model.

According to the teachings of the present embodiment a method for generating a three-dimensional (3D) model of a moving object includes providing a plurality of two-dimensional (2D) images of a scene sampled by an imaging sensor in motion; deriving a viewpoint for each of the plurality of 2D images; finding at least one segment in each of at least two of the plurality of 2D images, wherein the at least one segment includes a moving object; and generating a 3D model of each of the moving objects using at least one segment in each of at least two of the plurality of 2D images with corresponding viewpoints.

In an optional embodiment, generating a 3D model further includes: determining correspondences between elements of the at least one segment for each moving object; associating the at least one segment for each moving object with a segment viewpoint corresponding to the viewpoint of the 2D image in which the at least one segment is found; calculating a rotation and translation (R&T) for each of the moving objects in each of the plurality of 2D images using the segment viewpoint with the correspondences; and generating a 3D model of each of the moving objects using the at least one segment with the segment viewpoint and R&T for each of the moving objects.

In another optional embodiment, providing a plurality of 2D images of a scene further includes selecting, based on a given criteria, from the plurality of 2D images, key 2D images to be used to generate the 3D model. In another optional embodiment, providing a viewpoint for each of the 2D images uses a simultaneous location and mapping (SLAM) technique. In another optional embodiment, finding at least one segment uses an optical flow technique. In another optional embodiment, finding at least one segment uses a range-based variational technique. In another optional embodiment, finding at least one segment uses a background filtering technique. In another optional embodiment, finding at least one segment uses a video motion detection (VMD) technique.

In an optional embodiment, finding at least one segment uses a method for detecting a moving object including: providing a plurality of two-dimensional (2D) images of a scene sampled by an imaging sensor in motion; deriving a viewpoint for each of the plurality of 2D images; constructing a static scene three-dimensional (3D) model of the scene using the plurality of 2D images and associated viewpoints; projecting the static scene 3D model to generate a projected 2D image from a target viewpoint; and comparing the projected 2D image to a 2D image from the target viewpoint to, find at least one segment that includes a moving object.

Other optional embodiments include: determining correspondences between elements is done sparsely, determining correspondences between elements is done sparsely using a feature tracking technique; determining correspondences between elements is done densely; determining correspondences between elements is done densely using an optical flow technique; calculating a R&T further includes using a smoothness constraint on the R&T of each moving object; calculating an R&T further includes using a motion model to improve robustness of the solution.

Other optional embodiments include one or more steps of: classifying moving objects; identifying moving objects; identifying moving objects using the 3D model; information derived from 3D model generation is used to control the movement of one or more real-time, moving, image capture devices; information derived from 3D model generation is used to control providing of 2D images from one or more data storage devices.

According to the teachings of the present embodiment there is provided a system for generating a three-dimensional (3D) model of a moving object including: at least one two-dimensional (2D) image source configured to provide a plurality of 2D images of a scene sampled by an imaging sensor in motion; and a processing system containing one or more processors, the processing system being configured to: derive a viewpoint for each of the plurality of 2D images; at least one segment in each of at least two of the plurality of 2D images, wherein the at least one segment includes a moving object; and generate a 3D model of each of the moving objects using at least one segment in each of at least two of the plurality of 2D images with corresponding viewpoints.

In an optional embodiment, the processing system is further configured to generate a 3D model by: determining correspondences between elements of the at least one segment for each moving object; associating the at least one segment for each moving object with a segment viewpoint corresponding to the viewpoint of the 2D image in which the at least one segment is found; calculating a rotation and translation (R&T) for each of the moving objects in each of the plurality of 2D images using the segment viewpoint with the correspondences; and generating a 3D model of each of the moving objects using the at least one segment with the segment viewpoint and R&T for each of the moving objects.

In other optional embodiments, at least one 2D image source includes a digital picture camera, a digital video camera, and/or a storage system.

In another optional embodiment, at least one 2D image source is configured to provide a plurality of 2D images of a scene by selecting, based on a given criteria, from the plurality of 2D images, key 2D images to be used to generate the 3D model.

In another optional embodiment, the processing system is further configured to find at least one segment by: constructing a static scene three-dimensional (3D) model of the scene using the plurality of 2D images and associated viewpoints; projecting the static scene 3D model to generate a projected 2D image from a target viewpoint; and comparing the projected 2D image to a 2D image from the target viewpoint to find at least one segment that includes a moving object.

In other optional embodiments, the processing system is further configured to classify moving objects, identify moving objects, and/or identify each moving object using the 3D model.

In another optional embodiment, the system is further configured to use information derived from 3D model generation to control the movement of one or more real-time, moving, image capture devices. In another optional embodiment, the system is further configured to use information derived from 3D model generation to control the providing of 2D images from one or more data storage devices.

According to the teachings of the present embodiment a system for detecting a moving object includes: at least one two-dimensional (2D) image source configured to provide a plurality of 2D images of a scene sampled by an imaging sensor in motion; and a processing system containing one or more processors, the processing system being configured to: derive a viewpoint for each of the plurality of 2D images; construct a static scene three-dimensional (3D) model of the scene using the plurality of 2D images and associated viewpoints; project the static scene 3D model to generate a projected 2D image from a target viewpoint; and compare the projected 2D image to a 2D image from the target viewpoint to find at least one segment that includes a moving object.

### BRIEF DESCRIPTION OF FIGURES

The embodiment is herein described, by way of example only, with reference to the accompanying drawings, wherein:

FIG. 1 is a simplified flowchart of a method for detection, tracking, classification, and identification of a moving object from a moving sensor.

FIG. 2 is a flowchart of a method for generating a three-dimensional (3D) model of a moving object from a moving sensor.

FIG. 3 is a flowchart of a method for detecting moving objects.

FIG. 4 is a diagram of a system for generating a three-dimensional (3D) model of a moving object.

### DETAILED DESCRIPTION

The principles and operation of the system and method according to a present embodiment may be better understood with reference to the drawings and the accompanying description. A present embodiment is a system and method for detection, tracking, classification, and/or identification of a moving object from a moving sensor using a three-dimensional (3D) model. The system facilitates generation of a 3D model using images from a variety of sensors, in particular passive two-dimensional (2D) image capture devices. 2D images are processed to determine viewpoint and find moving objects in the 2D images. Conventional techniques or an innovative technique can be used to find segments of 2D images having moving objects. Viewpoint and segment information is used for generation of a 3D model of an object, in particular using both object motion and sensor motion to generate the 3D model.

2D images, as generally known in the field, are a set of data where each datum is indexed by a 2D designator (typically x, y), and the value of each datum represents a texture. In contrast, data sets like LADAR images are indexed by a 2D designator, but the value of each datum represents a distance from a viewpoint. In 3D models, each datum is indexed by a 3D designator and the value of each datum can vary depending on the application. A 3D model is a data structure for describing the position and shape of one or more portions or objects of interest (referred to hereafter as object for simplicity) in a given three-dimensional coordinate system (typically x, y, z). A 3D model can represent a whole scene (also known as an area of interest) or a subset of a scene (a portion of the area of interest, a subset of objects in the scene, and/or portion(s) of objects in the scene. A 3D model can vary in scale and level of detail, depending on the application. The specific data structure can vary depending on the application. Popular data structures include mesh—which describes the 3D object as a set of textured polygons, voxel space—which describes the presents or absence of a substance in every 3D coordinate, and point cloud—which lists a set of points in the 3D coordinate system that describe points on the 3D object.

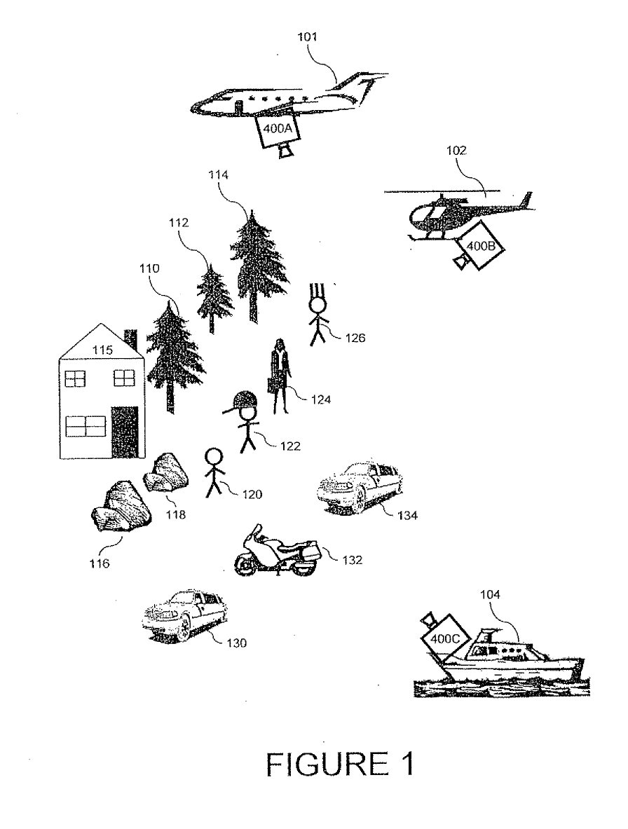

Referring now to the drawings, FIG. 1 is a simplified diagram of a method for detection, tracking, classification, and identification of a moving object from a moving sensor. One or more sensors (400A, 400B, 400C) can be located on an airplane 100, helicopter 102, ship 104, or other mobile platform. Sensors can include, but are not limited to, digital picture cameras and digital video cameras. 2D images from sensors can be provided to the system in real time, or stored and provided from storage for off-line processing. Captured 2D images can include a variety of objects. Non-limiting examples of objects include stationary objects, such as trees (110, 112, and 114), houses 115, and rocks (116, 118). Non-limiting examples of moving objects include people (120, 122, 124, and 126) and vehicles (130, 132, and 134). Note that moving objects can be stationary, moving, or pause while moving. For clarity, the description sometimes refers to a single sensor or processing of a single object, however, note that the technique of this implementation can be used with multiple sensors and/or to process multiple objects.

In a non-limiting operational example, an airplane 101 is flying and attached moving camera 400A captures 2D images of objects, including 122, 124, and 134. The 2D images are processed to find the moving objects and 3D models are created of each object (122, 124, and 134 respectively). The 3D models are used to classify each object, for example, objects 122 and 124 are classified as people, and object 134 is classified as a vehicle. In a case where an application is tracking people, object 134 does not need to be tracked or further processed. In a case where the application is looking for a specific person, objects 122 and 124 can be further processed for identification of who the object is. If object (person) 122 is not of interest, depending on the application, object 122 can be dropped from processing, or preferably tracked at a high level and knowledge of the position of object 122 can be fed back to reduce future processing requirements. Detailed information on tracking can be found in Israeli patent application number 197996 by Berkovich et al for An Efficient Method for Tracking People. In a case where object (person) 124 is of interest, object 124 can be tracked by the system, and information from the movement of object 124 can be fed back into the system to control the flight of airplane 101 and/or the angle of camera 400A.

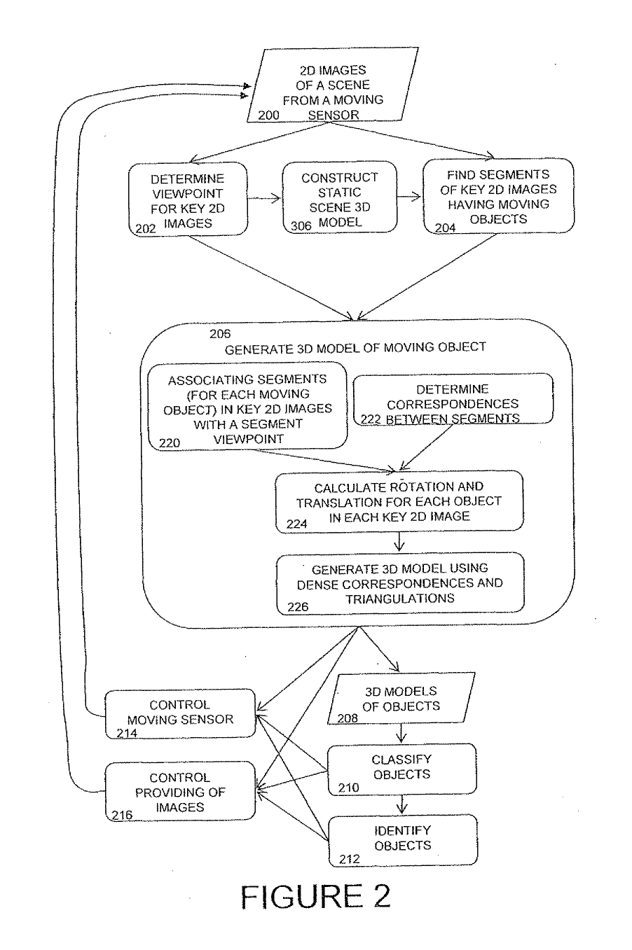

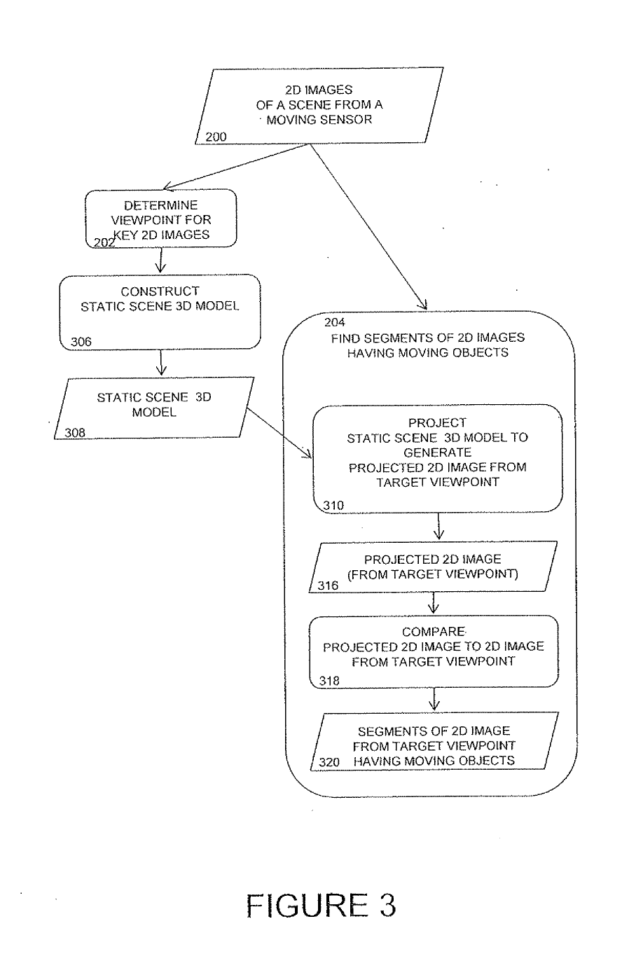

Referring now to the drawings, FIG. 2 is a flowchart of a method for generating a three-dimensional (3D) model of a moving object from a moving sensor. The 3D model can be used for object detection, object tracking, object classification, object identification, and controlling the sensor. A plurality of two-dimensional 2D images of a scene are provided from one or more moving imaging sensors in block 200. In the context of this description, a scene is an area or location of interest that is being viewed, or can be viewed by one or more sensors. As the sensor moves, the 2D images are captured from a plurality of viewpoints. In the context of this description, viewpoint refers to the sensor angle and position information, for example the position and angle of a camera. Viewpoint is also known in the field as six degrees of freedom (6DOF). The 2D images are used for deriving 202 the viewpoint for key 2D images. Detection of moving objects includes finding 204 segments of key 2D images having moving objects. In the context of this description, a moving object refers to an object that has detectable motion between key 2D images relative to a scene containing the object. In the context of this description, a segment refers to a portion, such as an area, subsection, or group of pixels in a 2D image. Segments can be found, in block 204, using conventional techniques, including comparing a plurality of 2D images to find corresponding segments with differing content, or using an innovative technique involving construction 306 of a static scene model, as described in reference to FIG. 3. The viewpoints and segments are used to generate 206 a 3D model of one or more moving objects. The 3D models 208 of objects can be used for additional processing, such as classifying 210 objects and identifying 212 objects. Results of 3D model generation 206 can be fed back and used to control 214 one or more of the sensors or control 216 one or more data storage devices providing 2D images.

As is known in the field, 2D images may be optionally preprocessed, including changing the data format, size, normalization, and other image processing necessary to prepare the images for processing. In the field, a viewpoint (camera angle and position) is generally provided with the image, but this provided viewpoint is generally not sufficiently accurate for the calculations that need to be performed, and so the viewpoint needs to be derived or determined 202 more precisely. In another case, a viewpoint is not provided with an image and the viewpoint needs to be determined. Techniques to calculate viewpoints are known in the art. In a case where the sensor is moving, or multiple sensors in known locations capture images of a scene, ego motion algorithms can be used to determine viewpoint information from the images. The output of an ego motion algorithm includes the viewpoint information associated with the input image, including the position and orientation of the sensor relative to the scene. Other known techniques to provide accurate viewpoint information from a sequence of 2D images include structure from motion (SFM) and simultaneous location and mapping (SLAM).

Providing a plurality of 2D images of a scene 200 optionally includes processing the 2D images to determine key 2D images, and providing only the key, 2D images. Note that in this case, key 2D images of a scene 200 are provided to determine 202 the viewpoint for key 2D images and find 204 segments of key 2D images having moving objects. Key images (also known as key frames) are 2D images chosen, based on a criteria, from the plurality of 2D images, for further processing. In one non-limiting example, real-time images are provided at a high rate of 100 frames per second (fps), but the application only requires 20 fps, so the provided images are decimated to provide every fifth image (20/100) as a key 2D image for processing.

Finding segments of key 2D images having moving objects 204 includes finding at least one segment in each of a plurality of the 2D images (key images). In other words, to detect a moving object, segments are found for a moving object in multiple key 2D images, but not necessarily in every key 2D image. This can occur when a moving object pauses or is occluded—in the key 2D images captured when the object is moving or visible, segments will be found. When the object is occluded, segments will not be found for the moving object. Depending on the application, the object can be tracked using conventional techniques and additional segments found when the object becomes visible. Conventional techniques for finding segments include, but are not limited to optical flow—finding portions of 2D images with significant difference between the optical flow of a local environment and the surrounding average optical flow which represents global motion, range-based—finding portions of 2D images with significant difference between a change of a range between a local environment and a change of range of a surrounding area which represents global motion, background filtering—using a sequence of images to statistically represent the properties of a static scene (known as background modeling) thus enabling the segmentation of dynamic objects in the scene, and video motion detection (VMD) techniques—performing registration of subsequent image pairs and then applying image differencing and thresholding. An innovative technique for finding segments includes projecting a static scene 3D model, and is described in reference to FIG. 3. Because segments can be affected by noise, in an optional implementation, a smoothness constraint or a motion model is used to improve the finding of segments.

Note that in some applications, if moving objects are not found in a 2D image (no segments are found), this information may be of interest to the application and can be provided appropriately.

Generating 206 a 3D model of one or more moving objects involves determining 222 correspondences between segments and associating 220 segments (for each moving object) in key 2D images with a segment viewpoint, which are used to calculate 224 a rotation and translation (R&T) for each of the moving objects in each of the key images. The R&T is then used in combination with the previously determined information to generate 226 a 3D model of each of the moving objects.

In block 222, correspondences are determined between elements of the segments for each moving object. In the context of this document, correspondences are the results of a function that matches elements from one image to elements or element coordinates in a second image. In the context of this document, the term element refers to a unit or component of a 2D image. Elements are commonly pixels, but depending on the application can also be areas or other relevant parts of the image. Techniques for finding correspondences are known in the art, and include finding correspondences between pixels in the segments of each appearance of a moving object sparsely by feature tracking based methods or densely by, for example, optical flow based methods. Dense correspondences are correspondences between a majority of the elements in each 2D image. Sparse correspondences are for a sub-group of elements, chosen based on a criteria, for example high information content (which makes the element easier to match). Sparse correspondences are typically less than 10%, and preferably not more than 3%, of the elements.

In block 220, at least one segment of the key 2D images for each moving object is associated with a segment viewpoint. In this context, the segment viewpoint is the viewpoint of the 2D image in which the segment is found.

In block 224, the determined correspondences are used with the segment viewpoints to calculate a rotation and translation (R&T) for each of the moving objects in each of the key images. One method for solving the R&T of the moving objects includes using a bundle adjustment technique followed by post processing. Another method for calculating R&T is to solve all constraints simultaneously. Another method for calculating the R&T for each of the moving objects includes using a fundamental matrix (FM). One method for finding the R&T using a fundamental matrix includes defining constraints on the R&T and solving the parameters of the R&T in a non-linear equation system. This method is similar to the technique of bundle adjustment, or simultaneously with the constraints of bundle adjustment. Since the R&T is time dependant, to improve the robustness of the solution, the R&T can include a smoothness constraint on each moving object and/or use of a motion model. Applying a smoothness constraint or motion model can help reduce the effect of noise in segments used for each moving object.

The R&T for each moving object is used in combination with the segments for the moving object and segment viewpoints to generate 226 a 3D model of the moving object. Viewpoint and segment information is used for generation of a 3D model of an object, in particular using both object motion and sensor motion to generate the 3D model. A sensor model can be used as an intermediate step and output if desired. Depending on the application, solving sensor motion and solving object motion can be performed separately or simultaneously. The R&T takes into account an object's motion. Dense correspondences between segments for each moving object are used with multiple-view-triangulations between the segments based on combined R&T and viewpoints to generate a 3D model 208 of the moving object.

The current embodiment can be used with 2D images where a minority of the objects are moving or where a majority of the objects are moving. The static information in the 2D images is used to determine viewpoint (including camera motion) and calculate R&T (including fundamental matrix). Enough static information is needed to be able to determine sufficiently accurate viewpoints and R&Ts. In general, in current implementations, at least six correspondences are needed for viewpoint reconstruction. It is foreseen that alternative algorithms may require less correspondences. Preferably, on the order of tens of correspondences are used for redundancy, outliers, and numerical stability.

The generated 3D models 208 of objects can be used to provide a variety of additional capabilities, such as classifying 210 objects and identifying 212 objects, using conventional techniques. As described in the example in reference to FIG. 1, moving objects can be classified into general categories. The designation and use of general categories depends on the application. Common categories include people, vehicles, and animals. An intrusion detection system may be interested in classification to facilitate tracking of people, while ignoring small animals, whereas a traffic monitoring system may be interested in moving objects that are vehicles, while ignoring pedestrian travelers.

Classified objects can be further processed to identify 212 the specific type of object. Referring again to FIG. 1, moving objects that have been classified as vehicles (130, 132, and 134) can be further identified as to the type of vehicle: Vehicles 130 and 134 are identified as cars, and vehicle 132 is identified as a motorcycle. A traffic system may be interested in identification of vehicles so that highway planning personnel can take into consideration both motorcycle (132) and car (130, 134) traffic. Generated 3D face models can be used to identify the specific identity of a moving person.

The results of 3D model generation 206 can be fed back and used to control the providing of 2D images. In a case where the images are being provided in real-time, control 214 can be of one or more moving sensors to facilitate providing additional images necessary to construct or improve a 3D model, and/or to track one or more moving objects (for example, to keep a target under surveillance). In a case where 2D images are being provided from storage, the results of 3D model generation 206 can be fed back and used to control 216 providing of 2D images from one or more data storage devices.

Information from classification 210 and identification 212 can also be fed back to control 214, 216 the providing of 2D images 200, or to help direct, optimize, or eliminate other processing. Directing processing includes feedback as to where in a key 2D image to find segments of interest (in block 204), or alternatively eliminating the need to process an entire key 2D image (in block 204), because the content of portions of the image do not contain objects of interest to the application. For clarity in FIG. 2, only a few feedback lines have been drawn. Based on the above description, one skilled in the art will be able to implement feedback appropriate to an application.

Referring to FIG. 3, a flowchart of a method for detecting moving objects, 2D images are provided 200, and viewpoints determined 202 similar to the description in reference to FIG. 2. Instead of using conventional techniques in block 204 to find segments of key 2D images having moving objects, an innovative technique for finding segments includes projecting a static scene three-dimensional (3D) model (310-320).

After respective viewpoints have been determined 202 for key 2D images, a static scene 3D model 308 is constructed 306. In the context of this description, a static scene 3D model is a 3D model of a scene that contains only stationary objects. One technique for construction of a static scene 3D model includes using bundle adjustment on a multitude of key 2D images. Voting or statistically discarding outliers provides the static information from the multitude of key 2D images to construct a static scene 3D model. Bundle adjustment and other techniques for constructing a static scene 3D model are known in the art. Based on this description, one knowledgeable in the art will be able to select a technique appropriate for the application.

The static scene 3D model 308 is projected 310 to generate a projected 2D image from, a target viewpoint 316. Projection is also known in the field as “warping”, and generating a 2D image from a 3D model is also known as rendering. Techniques for projection and rendering are known in the art, and based on this description, one knowledgeable in the art will be able to select a technique appropriate for the application. The target viewpoint can correspond to one of the determined viewpoints for the provided 2D images, or can be a new viewpoint.

The projected 2D image is compared 318 to a 2D image from the target viewpoint. In a case where the target viewpoint is one of the determined viewpoints for the provided 2D images, the corresponding 2D image can be used. In a case where the target viewpoint is a new viewpoint, feedback can be used to control the providing of 2D images to supply a new 2D image from the target viewpoint, similar to the description above. Because the projected 2D image is generated from a static scene, and both images have the same viewpoint, segments of the 2D image from the target viewpoint having moving objects can be easily found 320 using conventional techniques.

Some of the possible advantages of certain embodiments of a method for detecting moving objects can be seen from this last step. If a first 2D image had been projected to a target viewpoint, (directly, without using a static model) the projected 2D image would contain moving objects—in the same position, but from a different viewpoint. Conventional techniques would require extensive analysis of the 2D images to find segments containing moving objects.

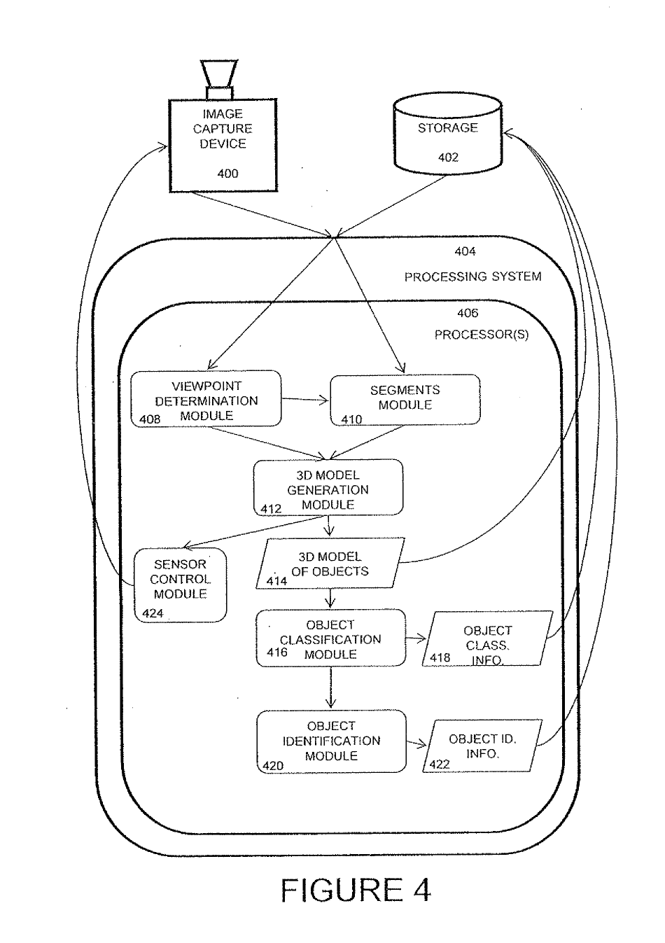

Referring to FIG. 4, a diagram of a system for generating a three-dimensional (3D) model of a moving object, this system can be used for detection, tracking, classification, and identification of a moving object from a moving sensor. One or more two-dimensional (2D) image sources are configured to provide a plurality of 2D images of a scene captured from a plurality of viewpoints. Image sources include, but are not limited to an image capture device 400 and a storage device 402. As described above, image capture devices include, but are not limited to, digital picture cameras and digital video cameras. In an optional implementation, the 2D image source is configured to process the plurality of 2D images of a scene to determine key 2D images, and provide only the key 2D images.

Processing system 404 contains one or more processors 406. Processors 406 are configured with a variety of modules. A viewpoint determination module 408 determines a viewpoint for each of the provided 2D images. A segments module 410 finds at least one segment in each of a plurality of the plurality of 2D images, wherein at least one segment includes a moving object. A 3D model generation module 412 determines correspondences between elements of the segments for each moving object, associates the segments of 2D images for each moving object with a segment viewpoint, calculates a rotation and translation (R&T) for each of the moving objects in each of the 2D images using the segment viewpoint with the correspondences, and generates a 3D model 414 of each of the moving objects using the segments with the R&T for each of the moving objects.

The processing system 404, and in particular the 3D model generation module 412, can be optionally configured to generate 3D model generation information (not shown) and use the 3D model generation information to control the providing of a plurality of 2D images of a scene from the 2D image source. In one implementation, the processing system is configured with a sensor control module 424 that uses 3D model generation information to control the providing of the plurality of 2D images from a 2D image source. In other implementations, post processing information (described below) and/or pre-processing information (for example, the baseline needed for high quality 3D reconstruction) is used to control the providing of the plurality of 2D images from a 2D image source. In a non-limiting example, sensor control module 424 controls image capture device 400, which is a real-time, moving, 2D image capture device, as described above.

The processing system can be further configured with an object classification module 416 to process 3D models of moving objects and classify each moving object. The object classification module 416 can optionally generate object classification information 418, and this post-processing information can be sent to storage 402 or used by the sensor control module 424 for control of the 2D image source.

The processing system can be further configured with an object identification module 420 to process objects that have been classified and perform identification of each moving object. The object identification module 420 can optionally generate object identification information 422, and this post-processing information can be sent to storage 402 or used by the sensor control module 424 for control of the 2D image source.

The processing system can find at least one segment in segments module 410 using the above-described methods, or using an innovative system for detecting a moving object including: a processing system containing one or more processors configured to determine a viewpoint for each of the plurality of 2D images; construct a static scene three-dimensional (3D) model of the scene using the plurality of 2D images and associated viewpoints; project the static scene 3D model and generate a projected 2D image from a target viewpoint; and compare the projected 2D image to a 2D image from the target viewpoint to find at least one segment that includes a moving object.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

It will be appreciated that the above descriptions are intended only to serve as examples, and that many other embodiments are possible within the scope of the present invention as defined in the appended claims.

What is claimed is:

1. A method for generating a three-dimensional (3D) model of a moving object comprising:
(a) providing a plurality of two-dimensional (2D) images of a scene sampled by an imaging sensor in motion;
(b) deriving a viewpoint for each of the plurality of 2D images;
(c) finding at least one segment in each of at least two of the plurality of 2D images, wherein said at least one segment includes a moving object; and
(d) generating a 3D model of each of the moving objects using at least one segment in each of at least two of the plurality of 2D images with corresponding viewpoints.

2. The method of claim 1 wherein generating a 3D model further includes:
(i) determining correspondences between elements of said at least one segment for each moving object;
(ii) associating said at least one segment for each moving object with a segment viewpoint corresponding to said viewpoint of the 2D image in which said at least one segment is found;
(iii) calculating a rotation and translation (R&T) for each of the moving objects in each of the plurality of 2D images using said segment viewpoint with said correspondences; and
(iv) generating a 3D model of each of the moving objects using said at least one segment with said segment viewpoint and R&T for each of the moving objects.

3. The method of claim 2 wherein calculating a R&T further includes using a smoothness constraint on the R&T of each moving object.

4. The method of claim 2 wherein calculating an R&T further includes using a motion model.

5. The method of claim 1 wherein providing a plurality of 2D images of a scene further includes selecting, based on a given criteria, from said plurality of 2D images, key 2D images to be used to generate said 3D model.

6. The method of claim 1 wherein deriving a viewpoint for each of the 2D images uses a simultaneous location and mapping (SLAM) technique.

7. The method of claim 1 wherein finding at least one segment uses an optical flow technique.

8. The method of claim 1 wherein finding at least one segment uses a range-based variational technique.

9. The method of claim 1 wherein finding at least one segment uses a background filtering technique.

10. The method of claim 1 wherein finding at least one segment uses a video motion detection (VMD) technique.

11. The method of claim 1 wherein finding at least one segment uses a method for detecting a moving object comprising:
(a) providing a plurality of two-dimensional (2D) images of a scene sampled by an imaging sensor in motion;
(b) deriving a viewpoint for each of the plurality of 2D images;
(c) constructing a static scene three-dimensional (3D) model of the scene using the plurality of 2D images and associated viewpoints;
(d) projecting said static scene 3D model to generate a projected 2D image from a target viewpoint and
(e) comparing said projected 2D image to a 2D image from said target viewpoint to find at least one segment that includes a moving object.

12. The method of claim 1 further including a step of classifying moving objects.

13. The method of claim 1 further including a step of identifying moving objects.

14. The method of claim 1 further including a step of identifying moving objects using said 3D model.

15. The method of claim 1 wherein information derived from 3D model generation is used to control the movement of one or more real-time, moving, image capture devices.

16. The method of claim 1 wherein information derived from 3D model generation is used to control providing of 2D images from one or more data storage devices.

17. A method for detecting a moving object comprising:
(a) providing a plurality of two-dimensional (2D) images of a scene sampled by an imaging sensor in motion;
(b) deriving a viewpoint for each of the plurality of 2D images;
(c) constructing a static scene three-dimensional (3D) model of the scene using the plurality of 2D images and associated viewpoints;
(d) projecting said static scene 3D model to generate a projected 2D image from a target viewpoint and
(e) comparing said projected 2D image to a 2D image from said target viewpoint to find at least one segment that includes a moving object.

18. The method of claim 17 wherein constructing a static scene 3D model uses a bundle-adjustment technique.

19. The method of claim 17 wherein said target viewpoint corresponds to one of the viewpoints.

20. A system for generating a three-dimensional (3D) model of a moving object comprising:
(a) at least one two-dimensional (2D) image source configured to provide a plurality of 2D images of a scene sampled by an imaging sensor in motion; and
(b) a processing system containing one or more processors, said processing system being configured to:
(i) derive a viewpoint for each of the plurality of 2D images;
(ii) find at least one segment in each of at least two of the plurality of 2D images, wherein said at least one segment includes a moving object; and
(iii) generate a 3D model of each of the moving objects using at least one segment in each of at least two of the plurality of 2D images with corresponding viewpoints.

21. The system of claim 20 wherein said processing system is further configured to generate a 3D model by:
(i) determining correspondences between elements of said at least one segment for each moving object;
(ii) associating said at least one segment for each moving object with a segment viewpoint corresponding to said viewpoint of the 2D image in which said at least one segment is found;
(iii) calculating a rotation and translation (R&T) for each of the moving objects in each of the plurality of 2D images using said segment viewpoint with said correspondences; and
(iv) generating a 3D model of each of the moving objects using said at least one segment with said segment viewpoint and R&T for each of the moving objects.

22. The system of claim 20 wherein said at least one 2D image source is configured to provide a plurality of 2D images of a scene by selecting, based on a given criteria, from said plurality of 2D images, key 2D images to be used to generate said 3D model.

23. The system of claim 20 wherein said processing system is further configured to find at least one segment by:
(a) constructing a static scene three-dimensional (3D) model of the scene using the plurality of 2D images and associated viewpoints;
(b) projecting said static scene 3D model to generate a projected 2D image from a target viewpoint; and
(c) comparing said projected 2D image to a 2D image from said target viewpoint to find at least one segment that includes a moving object.

24. The system of claim 20 wherein said processing system is further configured to classify moving objects.

25. The system of claim 20 wherein said processing system is further configured to identify moving objects.

26. The system of claim 20 wherein said processing system is further configured to identify each moving object using said 3D model.

27. The system of claim 20 wherein said processing system is further configured to use information derived from 3D model generation to control the movement of one or more real-time, moving, image capture devices.

28. The system of claim 20 wherein said processing system is further configured to use information derived from 3D model generation to control the providing of 2D images from one or more data storage devices.

29. A system for detecting a moving object comprising:
(a) at least one two-dimensional (20) image source configured to provide a plurality of 2D images of a scene sampled by an imaging sensor in motion; and
(b) a processing system containing one or more processors, said processing system being configured to:
(i) derive a viewpoint for each of the plurality of 2D images;
(ii) construct a static scene three-dimensional (3D) model of the scene using the plurality of 2D images and associated viewpoints;
(iii) project said static scene 3D model to generate a projected 2D image from a target viewpoint; and
(iv) compare said projected 2D image to a 2D image from said target viewpoint to find at least one segment that includes a moving object.
